(19) United States
(12) Patent Application Publication
(10) Pub. No.: US 2026/0267654 A1
(43) Pub. Date: Sep. 10, 2026

(54) COORDINATE THREAD EXECUTION IN MULTI-CLUSTER ARCHITECTURES

(71) Applicant: QUALCOMM Incorporated, San Diego, CA (US)

(72) Inventors: Mallikarjunan MARIMUTHU, Coimbatore (IN); Vishnu Vardhan KASILIYA SUDARSAN, Bangalore (IN)

(21) Appl. No.: 19/074,739

(22) Filed: Mar. 10, 2025

(51) Int. Cl. G06F 9/38; G06F 9/50

(52) U.S. Cl. CPC G06F 9/3888; G06F 9/3851; G06F 9/5027

(57) ABSTRACT

A system includes a memory and a control circuit. The control circuit is coupled to the memory. The control circuit detects initiation of an application. The application includes a workload. The control circuit determines that a size of the workload is greater than a workload threshold value. Based on the size of the workload being greater than the workload threshold value, the control circuit identifies two threads among various threads of the workload, based on a transfer of data between the threads. A transfer of data from one thread to a different thread that are identified, is beyond a thread threshold value. The control circuit coordinates an execution of the identified two threads on a single processing cluster amongst various processing clusters.

### BACKGROUND

### Field of the Disclosure

The present disclosure relates generally to multi-core cluster systems, and, more particularly, to execution of threads on a multi-core cluster.

### Description of Related Art

In modern computing systems, a multi-core cluster architecture is widely used to enhance the performance of applications. Within the multi-core cluster architecture, each processing cluster, made up of several cores, is responsible for executing threads associated with one or more tasks of the application thereby enabling parallel processing across multiple cores of the processing clusters. The applications, ranging from gaming and social media to payments and messaging, among others, can thus leverage such multi-core cluster architecture to run multiple threads concurrently, significantly improving processing speed and responsiveness.

Conventionally, threads are assigned to processing clusters on a sequential basis. For example, a first thread may be assigned to one processing cluster, while a second thread is assigned to another processing cluster. Although such sequential thread assignment method works in many scenarios, it can introduce delays when data needs to be transferred between processing clusters for thread execution. These delays can become challenging, especially in applications where low-latency and real-time processing is expected to provide a seamless user experience.

### SUMMARY

Aspects of the disclosure provide a system. The system may comprise a memory and a control circuit. The control circuit may be coupled to the memory. The control circuit may be configured to detect initiation of an application that may comprise a workload. The control circuit may be further configured to determine a size of the workload being greater than a workload threshold value. The workload may comprise a plurality of threads. The control circuit may be further configured to identify, based on the size of the workload being greater than the workload threshold value, at least a first thread and a second thread, among the plurality of threads. The first thread and the second thread may be related with a transfer of data from the first thread to the second thread being beyond a thread threshold value. The control circuit may be further configured to coordinate an execution of the first thread and the second thread on a single processing cluster of a plurality of processing clusters.

In certain aspects of the disclosure, a method may be disclosed. The method may be executed by a control circuit. The method may comprise detecting initiation of an application comprising a workload. The method may further comprise determining a size of the workload being greater than a workload threshold value. The workload may comprise a plurality of threads. The method may further comprise identifying, based on the size of the workload being greater than the workload threshold value, at least a first thread and a second thread, among the plurality of threads, that may be related with a transfer of data from the first thread to the second thread being beyond a thread threshold value. The method may further comprise coordinating an execution of the first thread and the second thread on a single processing cluster of a plurality of processing clusters.

In further aspects of the disclosure, a system may be disclosed. The system may comprise a plurality of processing clusters and a control circuit. The control circuit may be coupled to the plurality of processing clusters. The control circuit may be configured to detect initiation of an application. The application may comprise a plurality of threads. The control circuit may be further configured to identify at least a first thread and a second thread among the plurality of threads, that are related based on a transfer of data from the first thread to the second thread being beyond a thread threshold value. The control circuit may be further configured to coordinate an execution of the first thread and the second thread on a single processing cluster of the plurality of processing clusters.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of a few of the various ways in which the principles of various implementations may be employed and the described implementations are intended to include all such aspects and their equivalents.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an environment that facilitates coordination of threads in a multi-core cluster architecture, in accordance with certain aspects of the present disclosure;

FIGS. 2A and 2B are diagrams that illustrate a flowchart of a method (e.g., a process) executed by a control circuit of a system of the environment of FIG. 1 in accordance with certain aspects of the present disclosure;

FIG. 3 is a diagram that illustrates a flowchart of a method (e.g., a process) executed by the control circuit to identify threads based on telemetry logs, for assignment on a single processing cluster of the system of the environment of FIG. 1 in accordance with certain aspects of the present disclosure;

FIG. 4 is a diagram that illustrates a flowchart of a method (e.g., a process) executed by the control circuit of the system of the environment of FIG. 1 to identify threads based on tracked real-time transfer of data between the threads, for assignment on the single processing cluster in accordance with further aspects of the present disclosure;

FIG. 5 is a diagram that illustrates a flowchart of a method (e.g., a process) executed by the control circuit of the system of the environment of FIG. 1 to identify threads based on a trained machine learning model, for assignment on the single processing cluster in accordance with various aspects of the present disclosure;

FIG. 6 is a diagram that illustrates a high-level flowchart of a method (e.g., a process) executed by the control circuit of the system of the environment of FIG. 1 in accordance with certain aspects of the present disclosure; and

FIG. 7 is a diagram that illustrates a high-level flowchart of method (e.g., a process) executed by the control circuit of the system of the environment of FIG. 1 in accordance with further aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

At least one of a control circuit, a processing cluster, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Multi-core cluster architectures have been gaining traction due to numerous advantages offered by such architectures. For instance, such architecture enables concurrent processing of various threads of an application by way of processing clusters. In an exempt thread assignment mechanisms, the various threads of an application are assigned in a cyclic manner to each processing cluster. In an example, a number of processing clusters may be four. Thus, a first thread may be assigned to a first processing cluster, a second thread may be assigned to a second processing cluster, a third thread may be assigned to a third processing cluster, and a fourth thread may be assigned to a fourth processing cluster. The first through fourth processing clusters may thus execute the first through fourth threads, respectively. In a scenario, the execution of the fourth thread may be dependent on the execution of the first thread. Further stated, the data generated with the execution of the first thread may be prerequisite data to execute the fourth thread. As the first thread and the fourth thread are assigned to different processing clusters, such as the first processing cluster and the fourth processing cluster, respectively, a delay may occur in transferring the data from the first processing cluster to the fourth processing cluster. Thus, the execution of the fourth thread may be further delayed. When several such related threads are assigned to different processing clusters, a delay may occur in the execution of the threads thereby affecting an experience of a user.

Certain aspects disclosed herein provide methods, circuits, and systems that are adapted to coordinate execution of threads on processing clusters. For example, a control circuit may detect an initiation of an application. The application may include a workload. The control circuit may further determine a size of the workload. If the size of the workload may be greater than a workload threshold value, the control circuit may further identify at least a first thread and a second thread, among multiple threads of the workload, that may be related based on a transfer of data from the first thread to the second thread being beyond a thread threshold value. The control circuit may further coordinate an execution of the two threads on a single processing cluster amongst multiple processing clusters.

The system of the present disclosure may provide a solution to assign threads that are related based on a transfer of data between the threads being beyond the thread threshold value, to a single processing cluster. The threads may be identified via any of telemetry logs, tracked real-time transfer of data between the threads, or a machine learning model. The assignment of the execution of such related threads to the same processing cluster may ensure a reduced data transfer latency and access latency as compared to assigning such threads to different processing clusters. Thus, a seamless experience may be provided to a user of the system.

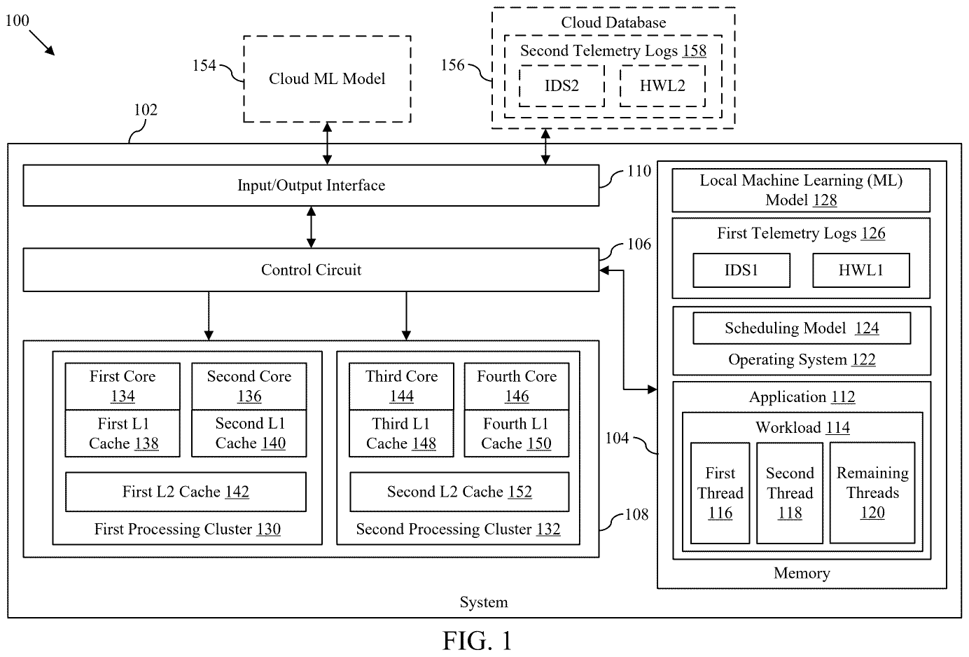

FIG. 1 is a diagram that illustrates an environment 100 for facilitating coordination of threads in a multi-core cluster architecture in accordance with certain aspects of the disclosure. In FIG. 1, the environment 100 is shown to include a system 102. The system 102 may be a device such as a processing device, a computing device, a group of devices, or the like. The system 102 may include a memory 104, a control circuit 106, a plurality of processing clusters 108 (e.g., a multi-core cluster), and an input/output interface 110. In one aspect, the control circuit 106, the memory 104, and the plurality of processing clusters 108 may be in a single device. Further, the control circuit 106 and the memory 104 may form a system that may be coupled to the plurality of processing clusters 108. Each of the plurality of processing clusters 108 may include more than one processing core, hereinafter referred to as “cores”. In further aspects, the control circuit 106 and the memory 104 may be in one device and the plurality of processing clusters 108 may be in a different device and the two devices may be coupled by way of a network interface. For the sake of simplicity and in a non-limiting example, it is assumed that the control circuit 106, the memory 104, and the plurality of processing clusters 108 are in a single device. The control circuit 106 may be communicatively coupled with the memory 104 and the plurality of processing clusters 108 by way of a communication bus of the system 102. Examples of the system 102 may include, but are not limited to, a cellular phone, a smartphone, a laptop, a desktop, a supercomputer, a notebook, a tablet, a phablet, a personal digital assistant, a satellite radio, a global positioning system device, a smart home device, intelligent lighting, a multimedia device, a video device, a digital audio player, a camera, a game console, an entertainment device, a vehicle component, a wearable computing device (e.g., a smartwatch, a health or fitness tracker, or eyewear), an appliance, a security device, a vending machine, a smart meter, or any other similar functioning device.

The memory 104 may be configured to store a plurality of applications of which, an application 112 is shown in FIG. 1. Examples of the application 112 may include, but are not limited to, a social media application, a computational application, a location service-based application, a payments-based application, an email application, a battery saving application, a gaming application, or the like. Examples of the memory 104 may include a random-access memory (RAM), a read-only memory (ROM), a floppy disk drive, a magnetic tape drive, a compact disc, an optical disk drive, a flash memory, a non-transitory computer-readable medium, or the like.

The application 112 may be divided into a plurality of workloads, each associated with the execution of specific tasks within the application 112. In one aspect, the application 112 may be stored in a user space of the memory 104 as a set of instructions or code segments. Such set of instructions or code segments may be organized into various units, which can be translated into discrete workloads (e.g., a plurality of workloads). Each workload may correspond to a specific task or operation to execute the application 112, such as processing video, handling network communication, or performing data storage. The application 112 can be developed by various sources such as software engineers, artificial intelligence (AI) models, or automated tools. In an example, the application 112 may be a social media application. Thus, the one or more tasks of the application 112 may involve video processing. Further, the corresponding workloads of the tasks may include object detection in a video, audio recognition in the video, video compression and encoding, or the like.

Each of the plurality of workloads can be either intensive in data transfer (alternatively referred to as being “data-intensive”) or non-intensive in data transfer based on a size of the corresponding workload. For example, a workload may be considered intensive in the data transfer based on a size of the workload being greater than a workload threshold value. The workload threshold value may vary with each of the plurality of applications or be the same for the plurality of applications. For example, one application may have the workload threshold value of 1 Gigabyte (GB), indicating that workloads exceeding such workload threshold value may be data-intensive, while a different application may have the workload threshold value in the range of 500 Megabytes (MB) to 800 MB. In one aspect, the workload threshold value may be defined and stored in the memory 104 for each of the plurality of applications. In an example, the workload threshold value may be defined to be 1 GB for the plurality of applications and be stored in the memory 104. In further aspects, the workload threshold value may be dynamic and determined in real-time during the execution of each of the plurality of applications, such as the application 112. In an example, the plurality of workloads may include fifty workloads. Thus, any five of the workloads that may have a size greater than a size of the remaining forty-five workloads may be considered to be data-intensive. In such a scenario, the workload threshold value may be determined based on a size of each of the five workloads. In FIG. 1, a workload 114 of the plurality of workloads is illustrated within the memory 104. In one example, a data-intensive workload such as the workload 114 may be indicative of a critical workload of the application 112.

The workload 114 may further be divided into a plurality of threads. In other words, the plurality of threads are created to process or execute the workload 114. A thread may represent a smallest unit of execution within the workload 114. For example, in the case of object detection in a video, the workload 114 may involve processing video frames, and the plurality of threads of the workload 114 can be associated with different tasks such as identifying objects within each video frame, tracking movement of the detected objects across the video frames, performing additional associated tasks such as filtering noise from each video frame, applying image enhancement algorithms, or the like. Though it is mentioned that the workload 114 may be divided into the plurality of threads, in various aspects, the application 112 may be divided into the plurality of threads without being divided into the plurality of workloads.

The plurality of threads may further be categorized into a first thread 116, a second thread 118, and remaining threads 120. If transfer of data between any two threads among the plurality of threads is greater than a thread threshold value, the two threads may be classified as the first thread 116 and the second thread 118. In other words, a first pair of threads, such as the first thread 116 and the second thread 118, may be related based on a transfer of data from the first thread 116 to the second thread 118 being beyond the thread threshold value. In one aspect, the thread threshold value may be predefined and stored in the memory 104. In further aspects, the thread threshold value may be dynamically determined in real-time based on the workload threshold value. Examples of the thread threshold value may include, but may not be limited to, 500 Kilobytes (KB), 800 KB, 2 MB, 10 MB, or the like. Thus, in a scenario, based on the thread threshold value being 5 MB, the transfer of data (e.g., an amount of data transfer) from the first thread 116 to the second thread 118 may be beyond the thread threshold value of 5 MB (e.g., 7 MB). In addition, a rate of data transfer from the first thread 116 to the second thread 118 may be based on the amount of the data transferred per second.

In one aspect, the first thread 116 may be a sender thread and the second thread 118 may be a receiver thread. Further, the second thread 118 may be executed based on the execution of the first thread 116. In such aspects, data transfer interaction between the first thread 116 and the second thread 118 may be managed using inter-process communication (IPC), where a communication pipe is created to facilitate data transfer between the sender and receiver threads of the application 112. The sender thread may create the communication pipe for data transmission, while the receiver thread may receive the data through the communication pipe.

In further aspects, the first pair of threads may include more than one receiver thread such as a third thread. The third thread may be similar to or different than the second thread 118. Additionally, the first thread 116 and the third thread may be related with a transfer of data from the first thread 116 to the third thread being beyond the thread threshold value. Such configuration may allow the first thread 116 to act as the sender thread for multiple receiver threads (e.g., the second thread 118 and the third thread), facilitating data distribution to multiple tasks associated with the application 112.

The remaining threads 120 may include various other threads. In an example, the remaining threads 120 may include threads that may be related by way of a data transfer between the threads, though the data transfer between such threads may be lower than the thread threshold value. In a scenario, based on the thread threshold value being 500 KB, the transfer of data between any two of the remaining threads 120 may be lower than the thread threshold value of 500 KB (e.g., 5 KB). In additional examples, some of the remaining threads 120 may be unrelated to each other. The unrelated threads may execute independent tasks within the application 112 that may not be associated with transfer of data between the threads. For example, one of the unrelated threads may be associated with a cryptographic operation. Similarly, the other unrelated threads may handle tasks such as mathematical operations or data filter operations. The unrelated threads may not consume data beyond the thread threshold value. The ongoing disclosure is explained in terms of the first thread 116 and the second thread 118 for the sake of simplicity, rather than detailing the other aforementioned threads. The first thread 116 and the second thread 118 may be scheduled for execution on one of the plurality of processing clusters 108 by the control circuit 106.

The control circuit 106 may include suitable circuitry configured to perform one or more operations associated with scheduling of threads. The control circuit 106 may be configured to detect initiation of the application 112, and determine a size of the workload 114 being greater than the workload threshold value. The control circuit 106 may be further configured to identify, at least the first thread 116 and the second thread 118. The control circuit 106 may further identify, that the first thread 116 and the second thread 118 may be related based on a transfer of data from the first thread 116 to the second thread 118 being beyond the thread threshold value. Further, the control circuit 106 may be configured to coordinate the execution of the first thread 116 and the second thread 118 on a single processing cluster of the plurality of processing clusters 108 as explained in the ongoing disclosure. Examples of the control circuit 106 may include but may not be limited to, an application-specific integrated circuit (ASIC) processor, a reduced instruction set computer (RISC) processor, a complex instruction set computer (CISC) processor, a field programmable gate array (FPGA), a microprocessor, a microcontroller, or the like. Further, the control circuit 106 may execute software using its own processing resources. Software shall be construed broadly to mean instructions, instruction sets, code, code segments, program code, programs, subprograms, software dies, applications, software applications, software packages, routines, subroutines, objects, executables, threads of execution, procedures, functions, etc., whether referred to as software, firmware, middleware, microcode, hardware description language, or otherwise.

Referring back to the memory 104, the memory 104 may be further configured to store at least an operating system 122. The operating system 122 may include a set of instructions that may enable management of resources of the system 102 to facilitate the execution of the application 112. In an example, the resources may include processing cores and cache memories within a processing cluster for the execution of the application 112. Various functions of the operating system 122 may be apparent to a person skilled in the art.

The operating system 122 may further include a scheduling model 124 that may execute a set of codes based on the application 112, to determine an order of execution of each thread, an execution time to process each thread, priority levels associated with each thread, a time instance to switch to a next thread upon an execution of a previous thread, a relation associated with transfer of data between one or more threads, or the like. In an example, the scheduling model 124 may identify the first thread 116 and the second thread 118 as related threads based on the transfer of data between the first thread 116 and the second thread 118. The scheduling model 124 may further identify that the execution of the second thread 118 may be based on the execution of the first thread 116. In some aspects, the scheduling model 124 may maintain a list of the plurality of processing clusters 108 and assigned threads to each processing cluster.

The scheduling model 124 may further generate assignment data to assign the threads to the plurality of processing clusters 108. The assignment data may be generated based on one or more cluster assignment parameters, and may include a mapping between each processing cluster and corresponding one or more threads. The scheduling model 124 may be executed by the control circuit 106. Thus, to explain the ongoing disclosure, the control circuit 106 may execute one or more operations of the scheduling model 124.

The memory 104 may be further configured to store first telemetry logs 126. The first telemetry logs 126 may be associated with historical execution of the plurality of applications. At least one of the plurality of applications may be similar to the application 112. The first telemetry logs 126 may include at least identifiers of a plurality of workloads (denoted as “HWL1” in FIG. 1) associated with each historical execution of the plurality of applications and a size of each of the plurality of workloads. One or more of the plurality of workloads (e.g., historical workloads) may have a size that may be greater than the workload threshold value. The first telemetry logs 126 may further include identifiers (denoted as IDS1” in FIG. 1) associated with historical first and second threads of the plurality of workloads. The first telemetry logs 126 may further include details associated with each historical application. In an example, the first telemetry logs 126 may include an identifier of each of the plurality of applications that have been executed historically, a number of threads created based on the historical workloads of each historical application and thread identifiers of each thread, a mapping between the plurality of processing clusters 108 and each thread, a data size (e.g., a memory space associated with each of the plurality of processing clusters 108 to execute the threads), data transferred within each of the plurality of processing clusters 108 for the execution of the historical application (e.g., an amount of the data transferred between historical first and second threads), context switch information of the threads, a number of interrupts in the execution of each historical application, or the like.

The memory 104 may be further configured to store a trained machine learning (ML) model, e.g., a local ML model 128. The local ML model 128 may be obtained based on training of a first ML model by way of training data that may include at least one of the first telemetry logs 126, a user feedback, or the like. Further stated, the training data may include an identifier of the application 112, details associated with the plurality of workloads of the application 112 such as identifiers and a size of each workload, identifiers of each thread associated with the application 112, data transferred between threads of each workload, whether the execution of the threads may be scheduled on a general processing unit (GPU) of the system 102, whether the application 112 is a multimedia application, or the like. The first ML model may be trained based on various deep learning methods. In an example, the first ML model may be trained based on a supervised learning method that may include providing the first telemetry logs 126 as training data to the first ML model. Thus, the first ML model may be trained to identify at least the workload 114, the first thread 116, and the second thread 118. Thus, the local ML model 128 may identify or predict the workload 114 based on an identifier of a previous workload similar to the identifier of the workload 114, a context of the workload 114 being similar to any of the workloads provided as the training data, or the like. Similarly, the local ML model 128 may identify the first thread 116 and the second thread 118 based on identifiers of previous first and second threads being similar to the identifiers of the first thread 116 and the second thread 118, or the like. In further examples, the first ML model may be trained based on a reinforcement learning method that may include providing the training data in real-time or near real-time based on a tracked data transfer amount or tracked data transfer rate associated with each thread of the application 112. The local ML model 128 may thus identify or predict the workload 114, the first thread 116, and the second thread 118 based on the tracked data transfer amount or the tracked data transfer rate and provide the identifier of each of the workload 114, the first thread 116, and the second thread 118 as an output. Thus, based on the reinforcement learning method, the local ML model 128 may be able to predict the first thread 116 and the second thread 118 for new applications (applications for which telemetry logs may be absent in the memory 104). The control circuit 106 may further identify the workload 114, the first thread 116, and the second thread 118 based on the output. In further examples, the first ML model may be trained based on an incremental learning method that may include providing the training data periodically to the first ML model, e.g., provide the user feedback along with the first telemetry logs 126 periodically. The training of the first ML model may be initiated periodically by a cloud server.

Referring now to further operations of the control circuit 106, the control circuit 106 may be further configured to generate the first telemetry logs 126. The control circuit 106 may be further configured to store the first telemetry logs 126 in the memory 104. The control circuit 106 may periodically track details of each historical application and update the first telemetry logs 126 based on the tracked details (e.g., the tracked data transfer amount or the tracked data rate between the threads). The control circuit 106 may identify each workload and historical first and second threads from the first telemetry logs 126 based on an analysis of the first telemetry logs 126. The first telemetry logs 126 may be analyzed by the control circuit 106 upon the initiation of the application 112. In one aspect, the control circuit 106 may access the first telemetry logs 126 to determine an amount of the data transfer between the first thread 116 and the second thread 118. In an example, the control circuit 106 may identify an identifier of the historical workload that may be similar to the workload 114. The control circuit 106 may further determine a size of the historical workload being greater than the workload threshold value. Thus, the control circuit 106 may determine the size of the workload 114 to be greater than the workload threshold value based on the similarities between the identifiers of the historical workload and the workload 114. The control circuit 106 may further identify the historical first and second threads based on the similarity between the identifiers of the historical first and second threads and the identifier of each of the first thread 116 and the second thread 118, respectively, and the amount of the data transfer between the historical first and second threads being beyond the thread threshold value. Thus, the control circuit 106 may identify the workload 114, the first thread 116, and the second thread 118 based on at least one of the identifiers of similar workloads and threads in the first telemetry logs 126 and the amount of the data transfer between the historical first and second threads being beyond the thread threshold value. The control circuit 106 may thus assign the first thread 116 and the second thread 118 to a single processing cluster for execution.

In further aspects, the control circuit 106 may identify an absence of historical data (e.g., the first telemetry logs 126) associated with the application 112 in the memory 104 upon the detection of the application 112. Thus, the control circuit 106 may identify that the application 112 is a new application that may not have been previously executed on the system 102. In such a scenario, prior to the determination of the size of the workload 114, the control circuit 106 may assign the threads of the application 112 to the plurality of processing clusters 108 for execution on the corresponding processing cluster. The threads may be assigned randomly or based on a round-robin scheduling policy to the plurality of processing clusters 108. Upon the assignment, the control circuit 106 may monitor the real-time transfer of data via a monitoring service such as a watchdog-like data access monitoring service for each thread. The control circuit 106 may execute the monitoring service. The watchdog service may utilize dedicated tools or services to monitor (e.g., track) and log a size of each workload and an amount of data transferred between the threads or the rate of data transfer between the threads of the application 112. Based on the size of the workload 114 being greater than the workload threshold value, the control circuit 106 may identify the workload 114. Further, based on the data transferred between the threads being beyond the thread threshold value, the control circuit 106 may identify the first thread 116 and the second thread 118 of the new application such as the application 112, and the first telemetry logs 126 may be updated to store details associated with the new application (e.g., the application 112). In one scenario, if the first thread 116 and the second thread 118 may be assigned to different processing clusters of the plurality of processing clusters 108, the control circuit 106 may manage migration of the first thread 116 and the second thread 118 from the different processing clusters to a single processing cluster (e.g., switch the context of the current execution of at least one of the first thread 116 and the second thread 118 from the current processing cluster to a single processing cluster). Further, for any future launch of the application 112, the first thread 116 and the second thread 118 can be identified to be assigned into the single processing cluster. The watchdog service may further enable execution of various functions by the control circuit 106 that may be associated with compliance, data integrity of the threads, or the like, as will be apparent to a person skilled in the art.

In further aspects, the control circuit 106 may further provide an input to the local ML model 128 based on the absence of the historical data associated with the application 112 in the first telemetry logs 126. Further, the control circuit 106 may preprocess the input by way of filtering operations to reduce erroneous data in the input. The input may include details associated with the application 112 (e.g., one or more parameters associated with the application 112 such as identifiers of workloads and threads, data rate, amount of data transferred, or the like). In an example, the input may be at least one of an identifier of the application 112, details of the workload 114 such as an identifier of the workload 114, real-time or near real-time data transferred between the threads of the application 112, or the like. In further aspects, the control circuit 106 may be configured to assess a set of power-related parameters that may be indicative of a performance profile of the system 102 prior to the identification of the first thread 116 and the second thread 118. Thus, the set of power-related parameters may be associated with power consumption of the system 102. Based on the set of power-related parameters associated with the system 102, the control circuit 106 may either provide an input to the local ML model 128, track the amount or rate of transfer of data in real-time between the threads, or access the first telemetry logs 126 to identify the first thread 116 and the second thread 118. The performance profile may be one of an alternating current (AC) mode (e.g., the system 102 may receive power from an external AC source), a direct current (DC) mode (e.g., the system 102 may receive power from a battery source), a balanced mode (e.g., the performance and power consumption of the system 102 may be balanced, a performance mode (e.g., the performance of the system 102 may be prioritized over power consumption), and a power saver mode (e.g., saving power may be prioritized over the performance of the system 102). In an aspect, in the performance mode and the AC mode that may desire high performance over saving power, the control circuit 106 may provide the input to the local ML model 128 or track the data transfer amount in real-time. Further, in the balanced mode where performance and moderate power consumption may be desired, the control circuit 106 may track the data transfer amount or rate in real-time or access the first telemetry logs 126 to identify the first thread 116 and the second thread 118. In addition, in the DC mode and the power saver mode where low power consumption may be desired, by the system 102, the control circuit 106 may access the first telemetry logs 126 to identify the first thread 116 and the second thread 118. In various aspects, the control circuit 106 may at least one of provide the input to the local ML model 128 and track the data transfer amount or rate, by default.

Upon identifying the first thread 116 and the second thread 118, the control circuit 106 may coordinate the execution of the first thread 116 and the second thread 118 on a single processing cluster based on the one or more cluster assignment parameters. The one or more cluster assignment parameters may be an affinity parameter, an availability parameter, a performance parameter, an operational parameter, or the like. Based on the affinity parameter (e.g., via affinity application programming interfaces “APIs”), the first thread 116 and the second thread 118 may be assigned to the same processing cluster for each execution of the application 112. Further stated, the assignment of the first thread 116 and the second thread 118 to the same processing cluster may be based on affinity of cores in a single processing cluster or previous assignment of threads to the processing cluster as indicated by the affinity parameter. The availability parameter may be indicative of an availability of a processing cluster (e.g., when the processing cluster may not be executing any previous thread or the processing cluster can accommodate the first thread 116 and the second thread 118 without interrupting the execution of other threads being executed on the processing cluster), a number of available cores in a processing cluster, a type of core, or the like. The operational parameter may refer to an operational frequency of each core to match a desired speed of thread execution, a number of instructions that may be executed at each core for each cycle, or the like. Further, the performance parameter may be based on the performance profile (e.g., an AC mode, a DC mode, a balanced mode, a performance mode, and a power saver mode) of the system 102.

In one aspect, the control circuit 106 may be configured to identify whether a single processing cluster can accommodate the execution of both of the first thread 116 and the second thread 118 (e.g., related threads) based on a number of cores in the processing cluster. In an example, based on the number of the first thread 116 and the second thread 118 being less than or equal to the number of cores in the processing cluster, the first thread 116 and the second thread 118 may be assigned to the single processing cluster based on the one or more cluster assignment parameters. In further examples, if the control circuit 106 may identify that the number of cores in a processing cluster is lower than the number of such related threads, the control circuit 106 may group the first thread 116 and the second thread 118 to match the number of cores in the processing cluster based on a priority level of each of the first thread 116 and the second thread 118.

In a scenario, a processing cluster may include two cores, and the related threads may be more than two threads. In such a scenario, the control circuit 106 may identify a priority level of each thread. The priority level may be based on parameters defined by a user such as a quality of service, multimedia data associated with the execution of the thread, dependency relationship with other threads, criticality of data associated with the execution of the thread, or the like. Thus, each such related thread may be assigned with at least one of a low priority level, an intermediate priority level, or a high priority level. The intermediate priority level may be lower than a highest priority level, and higher than a lowest priority level. For example, when the highest priority level may be “1” and the lowest priority level may be “3”, the intermediate priority level may be “2”.

In one aspect, the system 102 may be registered to avail a service associated with coordinating execution of the threads in various processing clusters. The service may be provided by a web server associated with a service provider. In one scenario, a first application associated with the service may be downloaded by a user on the system 102. In further scenarios, the user may register the system 102 on a web server that hosts the service. In both of the scenarios, a trained ML model associated with the service may be deployed on the system 102. The trained ML model may be stored in the memory 104 and be referred to as the local ML model 128. Further, upon registering for the service, the local ML model 128 may be configured to monitor the plurality of applications based on the launch of the plurality of applications or provision of the input to the local ML model 128.

The control circuit 106 may further be configured to generate a feedback request to receive the user feedback associated with the execution of the first thread 116 and the second thread 118 on the single processing cluster. The user feedback may be any of a binary feedback (such as P or F or 1 or 0), a text feedback such as Pass or Fail, Good or Bad, Yes or No, a rating feedback with 1 being the highest and 5 being the lowest, or the like. In an example, upon registering for the service associated with coordinating the execution of the first thread 116 and the second thread 118 on the single processing cluster, a performance speed may be improved by 30% as compared to scheduling such related threads on different processing clusters. The user feedback may thus be indicative of a “Good” feedback. The local ML model 128 may further be trained based on the received user feedback. An accuracy of the local ML model 128 to identify the first thread 116 and the second thread 118 may thus be improved over time based on the user feedback. In an example, when the user feedback is a positive feedback such as “1”, “Pass”, “P”, “Yes”, or “Good”, the local ML model 128 may continue to identify the first thread 116 and the second thread 118 based on the current training of the first ML model. Further, if the user feedback is a negative feedback such as “0”, “Fail”, “F”, “No”, or “Bad”, the local ML model 128 may be further updated and trained based on the negative feedback indicating a negative prediction of the first thread 116 and the second thread 118. Thus, based on the training of the local ML model 128 with the user feedback, the local ML model 128 may accurately predict the first thread 116 and the second thread 118. The local ML model 128 may further be trained for new applications based on such user feedback. An overall operation of the control circuit 106 is explained in further detail in the ongoing description.

Referring now to the plurality of processing clusters 108, the plurality of processing clusters 108 may include a first processing cluster 130 and a second processing cluster 132 that may be multi-core processing clusters. Each of the first processing cluster 130 and the second processing cluster 132 may include more than one core, an L1 cache memory (hereinafter referred to as “L1 cache”) associated with each core, and an L2 cache memory (hereinafter referred to as “L2 cache”). The first processing cluster 130 may include a first core 134, a second core 136, a first L1 cache 138, a second L1 cache 140, and a first L2 cache 142. Further, the second processing cluster 132 may include a third core 144, a fourth core 146, a third L1 cache 148, a fourth L1 cache 150, and a second L2 cache 152. The L1 cache may be associated with each core to store data for execution by the corresponding core. Further, the L2 cache may be associated with a processing cluster to share data between the cores of the same processing cluster. The first L1 cache 138, the second L1 cache 140, the third L1 cache 148, and the fourth L1 cache 150 may be thus associated with the first core 134, the second core 136, the third core 144, and the fourth core 146, respectively. Further, the first L2 cache 142 may be associated with the first core 134 and the second core 136, and the second L2 cache 152 may be associated with the third core 144 and the fourth core 146.

The plurality of processing clusters 108 may be one of a homogenous processing cluster or a heterogenous processing cluster. Each core of a processing cluster may be configured to execute a thread independently. Further, multiple threads may be assigned to one processing cluster for execution of the threads on various cores of the processing cluster. The execution of a thread may refer to fetching instructions from a corresponding L1 cache, processing the data associated with the thread based on the instructions, or the like.

In a homogenous architecture of the plurality of processing clusters 108, the cores may be high performance cores, power saving cores, or the like. Thus, the control circuit 106 may estimate the one or more cluster assignment parameters that may be based on a number of cores in a processing cluster (e.g., the availability parameter), a type of core, a maximum operational frequency of the core, instructions that may be executed by the core at each cycle (e.g., the operational parameter), a power profile such as a low power or battery saver mode, a high power mode, or the like, of the processing cluster (e.g., the performance parameter), or the like, to allocate or assign a group of threads to the corresponding processing cluster.

In one example, the first processing cluster 130 may include high performance cores and the second processing cluster 132 may include power saving cores. Thus, threads with the highest priority may be assigned to the first processing cluster 130 and threads with the lowest priority may be assigned to the second processing cluster 132.

The control circuit 106 may assign a corresponding thread for execution to each of the first core 134, the second core 136, the third core 144, and the fourth core 146. To assign the thread for execution, the control circuit 106 may store data and instructions associated with the thread in the corresponding L1 cache of the core to execute the thread. Thus, each of the first core 134, the second core 136, the third core 144, and the fourth core 146 may execute one or more threads based on the retrieval of instructions and data associated with the threads in the first L1 cache 138, the second L1 cache 140, the third L1 cache 148, and the fourth L1 cache 150, respectively. The first L1 cache 138, the second L1 cache 140, the third L1 cache 148, and the fourth L1 cache 150 may be a buffer or a random-access memory.

The L2 cache may be a common cache memory to each processing cluster. The L2 cache may be configured to store data and share the data between cores of the same processing cluster. In one example, the first L2 cache 142 may store data generated upon the execution of the first thread 116. Further, the second core 136 may retrieve the stored data from the L2 cache to execute the second thread 118. Similarly, the second L2 cache 152 may store data generated upon the execution of a thread by the third core 144 and the stored data from the second L2 cache 152 may be retrieved by the fourth core 146 to execute the thread assigned to the fourth core 146. The first L2 cache 142 and the second L2 cache 152 may be a buffer or a random-access memory.

Each of the plurality of processing clusters 108 may further include an L3 cache memory, referred to as “L3 cache”. The L3 cache may be shared across the plurality of processing clusters 108. Further stated, the cores of different processing clusters may be able to execute the threads based on an execution of at least two of the remaining threads 120 on a different processing cluster. In an example, the thread assigned to the third core 144 may utilize the data of the thread assigned to the first core 134. Thus, the data associated with the execution of the thread by the first core 134 may be stored in the L3 cache and retrieved from the L3 cache by the third core 144 for execution of the thread assigned to the third core 144.

A cloud ML model 154 may be maintained by a cloud server. A cloud database of the cloud server may store the cloud ML model 154. The cloud server may train the cloud ML model 154 based on training data. The training of the cloud ML model 154 may occur in a manner similar to the training of the local ML model 128. The cloud ML model 154 may further be trained based on the first telemetry logs 126. Further, the cloud ML model 154 may be similar to the local ML model 128. In one aspect, based on the training of the cloud ML model 154, the cloud ML model 154 may be deployed on the system 102 and be stored in the memory 104 as the local ML model 128. In further aspects, the cloud server that may maintain the cloud ML model 154 may be similar to or different than the cloud server which may maintain a cloud database 156.

The cloud database 156 may be configured to store second telemetry logs 158. In an example, the second telemetry logs 158 may include at least a plurality of workloads (denoted by “HWL2” in FIG. 1) associated with each historical execution of the plurality of applications and the size of each of the plurality of workloads. The applications stored on the cloud database 156 in the second telemetry logs 158 may be based on applications that may have been historically executed on the system 102 or systems different than the system 102. Further, a size of at least one of the plurality of workloads may be greater than the workload threshold value. The second telemetry logs 158 may further include identifiers (denoted by “IDS2” in FIG. 1) associated with historical first and second threads of at least one of the plurality of workloads. The cloud database 156 may be maintained by a cloud server. The control circuit 106 may generate an access request to access the second telemetry logs 158. The second telemetry logs 158 may be accessed by the control circuit 106 by way of the cloud server to identify the workload 114 and the first thread 116 and the second thread 118 based on the initiation of the application 112. Further, the second telemetry logs 158 may be updated periodically by the cloud server. In further aspects, the cloud ML model 154 may be trained based on the second telemetry logs 158. The cloud database 156 may alternatively be referred to as a memory that may be similar to the memory 104.

The input/output interface 110 may be configured to provide a communication interface between the system 102 (e.g., the control circuit 106) and components external to the system 102 such as one or more cloud servers, which may maintain at least one of the cloud database 156 or the cloud ML model 154.

Referring now to a detailed operation of the system 102, the control circuit 106 may detect the initiation of the application 112. The application 112 may be initiated by at least one of a user of the system 102, the system 102 (e.g., the control circuit 106) at regular intervals of time, or a server wirelessly coupled to the system 102 to configure updates in the system 102.

The control circuit 106 may select a mode of identification to determine the size of the workload 114 via at least one of (i) telemetry logs, e.g., the first telemetry logs 126 or the second telemetry logs 158, (ii) a monitoring service, e.g., a watchdog service, or (iii) a trained ML model, e.g., the local ML model 128 or the cloud ML model 154. The mode of identification may be based on at least one of a set of power-related parameters associated with the system 102, a previous execution of each of the plurality of applications that may be similar to the application 112, or a default selection. In one scenario, the control circuit 106 may access the first telemetry logs 126 or the second telemetry logs 158 to determine the workload 114 and identify the first thread 116 and the second thread 118. The mode of identification via the telemetry logs may be based on the set of power-related parameters (e.g., reduce power consumption by the system 102), the presence of historical telemetry logs (e.g., the first telemetry logs 126 or the second telemetry logs 158) associated with a historical application similar to the application 112 in the memory 104 or the cloud database 156, or a default selection of the mode of identification via the telemetry logs.

The control circuit 106 may thus access the first telemetry logs 126 or generate an access request to the cloud database 156 to access the second telemetry logs 158. In one aspect, the control circuit 106 may retrieve details associated with the historical application similar to the application 112 upon identifying that one of the first telemetry logs 126 or the second telemetry logs 158 may include details associated with the historical application similar to the application 112. In further aspects, the control circuit 106 may identify whether at least one application of the plurality of applications may be similar to the application 112. In further aspects, the control circuit 106 may access the second telemetry logs 158 based on absence of the details associated with the historical application in the first telemetry logs 126. The details associated with the historical application may include a historical plurality of workloads. The control circuit 106 may further retrieve the historical plurality of workloads (e.g., analyze the historical plurality of workloads) to identify a historical workload that may be similar to the workload 114.

The control circuit 106 may further determine whether a size of at least one of the retrieved workload (e.g., the historical workload similar to the workload 114) is greater than the workload threshold value. In one aspect, the historical workload may have a similar identifier as the workload 114. Further, a size of the historical workload may be greater than the workload threshold value based on a data transfer within the historical workload being greater than the workload threshold value.

In one aspect, if none of the retrieved historical workloads have a size greater than the workload threshold value, the control circuit 106 may assign the execution of the threads of the application 112 on the plurality of processing clusters 108 based on a default scheduling policy. In one aspect, the default scheduling policy may be a round-robin scheduling policy such that each thread may be assigned to one of the cores of the plurality of processing clusters 108 and the threads may be queued for execution on the cores. In further aspects, the default scheduling policy may be based on power and performance management (PPM) settings such that the threads that consume high power may be assigned for execution on high performance cores and threads that consume low power may be assigned on power saving cores. In further aspects, the default scheduling policy may be cluster affinity such that the threads that may transfer data with each other may be assigned on the cores that are in affinity with respect to each other. In further aspects, the default scheduling policy may be based on previous assignment of the threads to a corresponding core of the plurality of processing clusters 108.

In one aspect, the control circuit 106 may determine that the size of the historical workload is greater than the workload threshold value. Thus, the control circuit 106 may further determine whether two or more threads associated with the historical workload are related based on a transfer of data being beyond the thread threshold value. In further aspects, the control circuit 106 may determine two or more threads associated with the historical application that may be related based on a transfer of data being beyond the thread threshold value. Thus, the control circuit 106 may determine the data transferred between at least two such related threads. If the data transfer between the two threads (e.g., historical first and second threads) is beyond the thread threshold value, the two related threads (e.g., the first thread 116 and the second thread 118) of the workload 114 may be identified based on similar identifiers with the historical first and second threads.

The control circuit 106 may thus coordinate the execution of the first thread 116 and the second thread 118 on a single processing cluster such as the first processing cluster 130 based on one or more cluster assignment parameters. In an example, the first core 134 and the second core 136 may be high performance cores and the third core 144 and the fourth core 146 may be power saving cores. Thus, the first thread 116 and the second thread 118 may be assigned to the first processing cluster 130 (e.g., the first core 134 and the second core 136) and any of the remaining threads 120 may be assigned to the second processing cluster 132 (e.g., the third core 144 and the fourth core 146).

In further aspects, the control circuit 106 may identify a historical third thread. The historical third thread may have an identifier similar to the identifier of the third thread of the application 112. Further, the data transfer between the historical first and third threads may be beyond the thread threshold value. To assign the execution of each of the first thread 116, the second thread 118, and the third thread to a processing cluster, the control circuit 106 may identify the number of cores in the processing cluster. In one scenario, a number of cores in the first processing cluster 130 may be two. In such a scenario, the control circuit 106 may identify a priority level of at least one of the first thread 116, the second thread 118, and the third thread. The second thread 118 may have a higher priority than the third thread. The control circuit 106 may thus assign the first thread 116 and the second thread 118 to the first processing cluster 130 whereas the third thread may be assigned to a high-performance processing cluster of the plurality of processing clusters 108 based on the one or more cluster assignment parameters. In further scenarios, the number of cores in the first processing cluster 130 may be three. In such a scenario, the control circuit 106 may assign the first thread 116, the second thread 118, and the third thread to the first processing cluster 130.

Thus, the control circuit 106 may assign the execution of the first thread 116 and the second thread 118 to the first processing cluster 130. The data associated with the execution of the first thread 116 and the second thread 118 may be stored in the first L1 cache 138 and the second L1 cache 140, respectively. The first core 134 may execute the first thread 116, and the second core 136 may execute the second thread 118 based on the execution of the first thread 116. The data associated with the execution of the second thread 118 may be retrieved from the first L2 cache 142 based on the execution of the first thread 116. An output of the execution of the first thread 116 and the second thread 118 may be stored in the first L2 cache 142.

In further scenarios, the local ML model 128 may monitor the plurality of applications such as the application 112 based on the launch of any of the plurality of applications or the mode of identification being via the trained ML model. Further, the local ML model 128 may receive the input from the control circuit 106. The input may be provided based on at least one of the first telemetry logs 126, the second telemetry logs 158, and the tracked real-time data transfer between each thread. The local ML model 128 may provide based on the input, the output that indicates a thread identifier of each of the first thread 116 and the second thread 118. The control circuit 106 may thus identify the workload 114 and the first thread 116 and the second thread 118 based on the received output.

In various scenarios, the control circuit 106 may assign the plurality of threads to the plurality of processing clusters 108 based on the initiation of the application 112. Further, the monitoring service may be selected as the default mode of identification to determine the size of the workload 114. In one example, the plurality of threads may be randomly assigned to the plurality of processing clusters 108. In further examples, the plurality of threads may be assigned to the plurality of processing clusters 108 based on a round-robin scheduling policy.

The control circuit 106 may track an amount or rate of data transfer of each thread by way of monitoring services (e.g., the control circuit 106 may execute the monitoring service) such as a watchdog timer (e.g., the control circuit 106 may maintain the watchdog timer) that may be initialized to perform live monitoring of the amount or rate of data transfer between each thread. In an example, the control circuit 106 may determine a size of the workload 114 may be greater than the workload threshold value and the data transfer between the first thread 116 and the second thread 118 may be greater than the thread threshold value based on the tracked amount or rate of data transfer between each thread. The control circuit 106 may thus identify the first thread 116 and the second thread 118. In further aspects, the control circuit 106 may provide the tracked amount of the data transfer or the tracked rate of the data transfer in real-time to the local ML model 128 to receive the output.

The control circuit 106 may further determine whether the first thread 116 and the second thread 118 are assigned to different processing clusters (such as the first thread 116 being assigned to the first processing cluster 130 or the second thread 118 being assigned to the second processing cluster 132). The control circuit 106 may trigger the interrupt to halt the current execution of any of the first thread 116 or the second thread 118 based on the determination that first thread 116 and the second thread 118 may be assigned to different processing clusters.

Upon halting the execution of at least one of the first thread 116 or the second thread 118, either the first thread 116 may be reassigned (e.g., migrated) to the second processing cluster 132, the second thread 118 may be reassigned to the first processing cluster 130, or both the first thread 116 and the second thread 118 may be reassigned to a new processing cluster based on the one or more cluster assignment parameters. A context switching of the threads may occur during the reassignment of the threads. Thus, a current state of execution of the thread may be loaded on the assigned processing cluster. Further, the context switching of the threads may be stored in the memory 104 as the context switch information.

The control circuit 106 may further generate telemetry logs associated with the tracked amount or rate of the data transfer and initiate storage of the generated telemetry logs in at least one of the memory 104 (e.g., the first telemetry logs 126) or the cloud database 156 (e.g., the second telemetry logs 158). The control circuit 106 may further generate the feedback request to receive the user feedback.

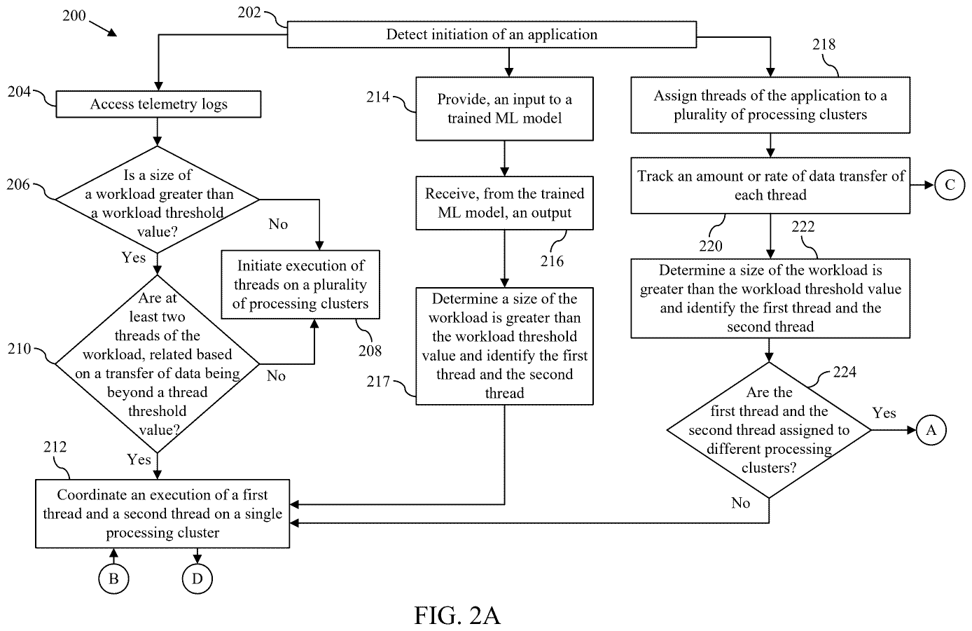

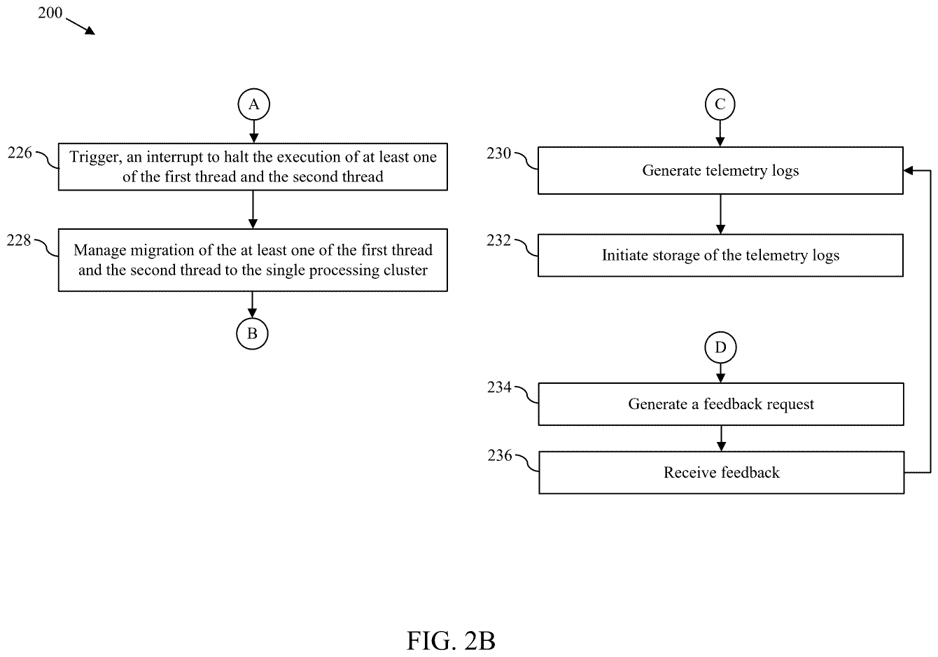

FIGS. 2A and 2B are diagrams that illustrate a flowchart 200 of a method (e.g., a process) executed by the control circuit 106 of the system 102 in accordance with certain aspects of the present disclosure. The flowchart 200 illustrates the various operations executed by the control circuit 106. FIGS. 2A and 2B are described in conjunction with FIG. 1.

At 202, an initiation of an application may be detected. The application 112 may be initiated by at least one of a user of the system 102, the control circuit 106 at regular intervals of time, or an external server to install the application 112 in the system 102. The control circuit 106 may thus detect the initiation of the application 112.

At 204, telemetry logs may be accessed. 204 may be executed after 202. Based on the initiation of the application 112, the control circuit 106 may access the first telemetry logs 126 or generate the access request to the cloud database 156 to access the second telemetry logs 158. The control circuit 106 may access the first telemetry logs 126 or the second telemetry logs 158 based on the presence of historical telemetry logs in the memory 104 or the cloud database 156, a set of power-related parameters indicating a DC mode or low power mode, the mode of identification being via the telemetry logs, or the like. In one aspect, the control circuit 106 may access the second telemetry logs 158 based on absence of historical telemetry logs associated with the application 112, e.g., absence of the first telemetry logs 126, in the memory 104. Based on a similarity of at least one application in either of the first telemetry logs 126 or the second telemetry logs 158 with the application 112, the control circuit 106 may further analyze the plurality of historical workloads associated with the application 112.

At 206, it is determined whether a size of a workload is greater than a workload threshold value. Upon accessing the telemetry logs (such as the first telemetry logs 126 or the second telemetry logs 158), the control circuit 106 may further determine whether a size of a workload such as a size of at least one of the historical workloads is greater than the workload threshold value in any of the first telemetry logs 126 or the second telemetry logs 158. If at 206, it may be determined that none of the historical workloads have a size greater than the workload threshold value, 208 may be executed.

At 208, an execution of threads on a plurality of processing clusters may be initiated. The control circuit 106 may assign the execution of the threads associated with the application 112 on the plurality of processing clusters 108 based on a default scheduling policy. The default scheduling policy may be a round-robin scheduling policy, PPM settings, cluster affinity, or the like.

At 210, it is determined whether at least two threads of the workload, are related based on a transfer of data being beyond a thread threshold value. 210 may be executed after 206. If at 206, it may be determined that at least one historical workload may have a size greater than the workload threshold value, 210 may be executed. On identifying the historical workload, the control circuit 106 may further determine whether two or more threads associated with the historical workload may be related with a transfer of data being beyond the thread threshold value. In one example, the identified historical workload may have an identifier similar to the identifier of the workload 114. To identify the threads, the control circuit 106 may determine the data transferred between each thread of the historical workload in either the first telemetry logs 126 or the second telemetry logs 158. If the data transferred between any two or more threads may be above the thread threshold value, such two or more threads may be identified by the control circuit 106. In an example, the identified two or more threads may be historical first and second threads that may have identifiers similar to the identifiers of the first thread 116 and the second thread 118, respectively. The control circuit 106 may thus identify the first thread 116 and the second thread 118. At 210, if it is determined that the historical workload may include unrelated threads, or threads that may be related with a transfer of data being lower than the thread threshold value, 208 may be executed.

At 212, an execution of the first thread and the second thread on a single processing cluster may be coordinated. 212 may be executed after 210, if it may be determined that at least two threads of the workload, are related based on a transfer of data being beyond the thread threshold value. The control circuit 106 may assign the execution of the first thread 116 and the second thread 118 on a single processing cluster such as the first processing cluster 130 based on the one or more cluster assignment parameters, to coordinate the execution of the first thread 116 and the second thread 118 on the first processing cluster 130.

At 214, an input to a trained ML model may be provided. 214 may be executed after 202. The input may be provided based on the mode of identification being via the local ML model 128, a set of power-related parameters indicating the performance mode and the AC mode, or the like. In one aspect, a trained ML model may be deployed on the system 102 based on a registration of the system 102 to avail the facility of coordination of threads on a single processing cluster. The trained ML model may be the local ML model 128 that may be stored in the memory 104. The trained ML model may be obtained based on training of the first ML model by way of the training data that may include at least one of the first telemetry logs 126, the second telemetry logs 158, the user feedback, or the like. In further aspects, the control circuit 106 may provide the input to the cloud ML model 154 by way of a cloud server. The input to the trained ML model may be the details associated with the application 112.

At 216, an output may be received from the trained ML model. The local ML model 128 may provide based on the input, the output that includes an identifier of the workload 114 and a thread identifier of each of the first thread 116 and the second thread 118. For the sake of simplicity of explaining FIGS. 2A and 2B, it is assumed that the local ML model 128 provides the output that may include the workload 114, the first thread 116, and the second thread 118.

At 217, a size of the workload being greater than the workload threshold value may be determined and the first thread and the second thread may be identified. The control circuit 106 may thus determine, based on the output, that the workload 114 has a size greater than the workload threshold value. The control circuit 106 may further identify that the first thread 116 and the second thread 118 may be related with a data transfer being beyond the thread threshold value. After 217, 212 may be executed. The control circuit 106 may thus coordinate the execution of the first thread 116 and the second thread 118 on a single processing cluster.

At 218, threads of the application may be assigned to a plurality of processing clusters. 218 may be executed after 202. In further aspects, the control circuit 106 may assign the plurality of threads to the plurality of processing clusters 108 upon detecting the initiated application 112 based on the mode of identification being via the balanced mode and the AC mode, a default assignment of the threads to the plurality of processing clusters 108, or absence of telemetry logs associated with the application 112. In one aspect, the plurality of threads may be randomly assigned to the plurality of processing clusters 108. In further aspects, the plurality of threads may be assigned to the plurality of processing clusters 108 based on a default scheduling policy.

At 220, an amount or rate of data transfer of each thread may be tracked. The control circuit 106 may track an amount or rate of data transfer of each thread by way of watchdog timers that may perform live monitoring of the amount or rate of data transfer between each thread. In an example, the watchdog timer may track the amount or rate of data transfer between the first thread 116 and the second thread 118.

At 222, a workload having a size greater than the workload threshold value may be determined and the first thread and the second thread may be identified. The control circuit 106 may determine that a size of the workload 114 may be greater than the workload threshold value. The control circuit 106 may identify the first thread 116 and the second thread 118 based on the data transfer between the first thread 116 and the second thread 118 being beyond the thread threshold value based on the tracked amount or tracked rate of data transfer.

At 224, it may be determined whether the first thread and the second thread are assigned to different processing clusters. The control circuit 106 may further determine whether the first thread 116 and the second thread 118 are assigned to different processing clusters (such as the first thread 116 being assigned to the first processing cluster 130 and the second thread 118 being assigned to the second processing cluster 132). At 224, if it may be determined that the first thread 116 and the second thread 118 may be assigned to a single processing cluster, e.g., the first thread 116 and the second thread 118 are not assigned to different processing clusters, 212 may be executed to coordinate the execution of the first thread 116 and the second thread 118 on a single processing cluster.

At 226, an interrupt to halt the execution of at least one of the first thread and the second thread may be triggered. If at 224, it may be determined that the first thread 116 and the second thread 118 may be assigned to different processing clusters, 226 may be executed. The control circuit 106 may trigger the interrupt to halt the current execution of any of the first thread 116 or the second thread 118 based on the determination that the first thread 116 and the second thread 118 are assigned to different processing clusters.

At 228, a migration of the at least one of the first thread and the second thread to a single processing cluster may be managed. The control circuit 106 may migrate at least one of the first thread 116 or the second thread 118 to a new processing cluster, migrate the first thread 116 to the processing cluster executing the second thread 118, or migrate the second thread 118 to the processing cluster executing the first thread 116. After 228, 212 may executed.

At 230, telemetry logs may be generated. 230 may be executed after 220. The control circuit 106 may generate or update the first telemetry logs 126 based on the tracked amount or rate of the data transfer between each thread of the application 112.

At 232, a storage of the telemetry logs may be initiated. The control circuit 106 may initiate the storage of the telemetry logs in the memory 104 for ease of identification of the first thread 116 and the second thread 118 in an event of a future launch of the application 112.

At 234, a feedback request may be generated. 234 may be executed after 212. The control circuit 106 may further generate the feedback request to receive the user feedback to determine an experience of the user upon availing the service for executing related threads on a single processing cluster.

At 236, a feedback associated with the feedback request may be received. The control circuit 106 may receive the feedback, e.g., the user feedback. The received user feedback may be provided to the local ML model 128 or the cloud ML model 154 for training and customization of the local ML model 128 on the system 102. Further, 230 may be executed after 236.

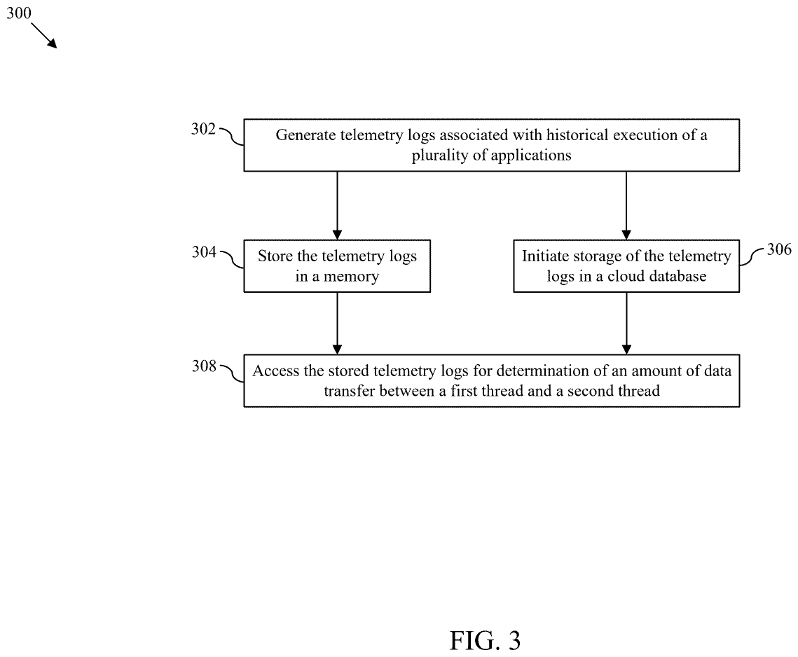

FIG. 3 is a diagram that illustrates a flowchart 300 of a method (e.g., a process) executed by the control circuit 106 to identify threads based on telemetry logs, for assignment on a single processing cluster of the system 102 in accordance with certain aspects of the present disclosure. FIG. 3 is described in conjunction with FIG. 1.

At 302, telemetry logs associated with historical execution of a plurality of applications may be generated. The control circuit 106 may generate the first telemetry logs 126 associated with historical execution of the plurality of applications. To generate the first telemetry logs 126, the control circuit 106 may track the amount or the rate of the data transfer between threads of historical applications and initiate storage of such telemetry logs in the memory 104. The first telemetry logs 126 may further include at least identifiers of the plurality of workloads associated with each historical execution of the plurality of applications, identifiers associated with the historical first and second threads of the plurality of workloads, details associated with the workloads such as the size of the historical workloads, an identifier of each historical application, a number of threads created based on the workloads of each historical application, a mapping between the plurality of processing clusters 108 and each thread, a data size (e.g., a memory space associated with each of the plurality of processing clusters 108) to execute the threads, data transferred within each of the plurality of processing clusters 108 for the execution of the historical application, context switch information of the threads, a number of interrupts in the execution of each historical application, or the like. Further, the control circuit 106 may periodically track such details of each historical application and update the first telemetry logs 126 based on the tracked details. After 302, both 304 and 306 may be executed.

At 304, the telemetry logs may be stored in a memory. The control circuit 106 may store the first telemetry logs 126 in the memory 104. At 306, a storage of the telemetry logs in a cloud database 156 may be initiated. In one aspect, the control circuit 106 may establish a secure communication via the input/output interface 110, with a cloud server that maintains the cloud database 156 to initiate storage of the first telemetry logs 126 associated with historical execution of the plurality of applications in the cloud database 156. The cloud server may thus update the second telemetry logs 158 based on each reception of the first telemetry logs 126 associated with the historical execution of the plurality of applications. After 304 and 306, 308 may be executed.

At 308, the stored telemetry logs for determination of an amount of data transfer between a first thread and a second thread may be accessed. The control circuit 106 may access the first telemetry logs 126 from the memory 104. Further, upon accessing the first telemetry logs 126, the control circuit 106 may analyze the first telemetry logs 126 to determine the amount of the data transfer between the historical first and second threads. In one aspect, the control circuit 106 may identify the workload 114, the first thread 116, and the second thread 118 based on at least one of the identifiers of similar workloads and threads in the first telemetry logs 126. In addition, the control circuit 106 may identify that the amount of the data transfer between the historical first and second threads may be beyond the thread threshold value. The control circuit 106 may thus identify the first thread 116 and the second thread 118. In further aspects, the control circuit 106 may access the second telemetry logs 158 to identify whether a historical workload and the historical first and second threads are stored in the second telemetry logs 158 that have identifiers similar to the identifier of the workload 114 and the first thread 116 and the second thread 118, respectively. The first thread 116 and the second thread 118 may thus be identified for coordination of execution of the first thread 116 and the second thread 118 on the single processing cluster.

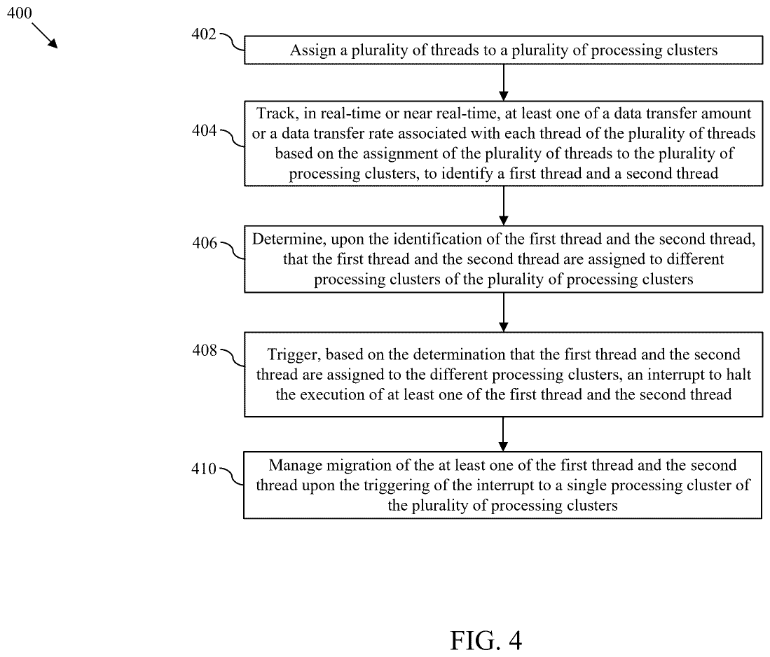

FIG. 4 is a diagram that illustrates a flowchart 400 of a method (e.g., a process) executed by the control circuit 106 of the system 102 to identify threads based on tracked real-time transfer of data between the threads, for assignment on the single processing cluster in accordance with further aspects of the present disclosure. FIG. 4 is described in conjunction with FIG. 1.

At 402, a plurality of threads to a plurality of processing clusters may be assigned. The control circuit 106 may assign the plurality of threads to the plurality of processing clusters 108. In one aspect, the control circuit 106 may randomly assign the threads of the application 112 to the plurality of processing clusters 108. For the sake of explaining FIG. 4, it is assumed that the first thread 116 and the second thread 118 may be assigned to different processing clusters.

At 404, at least one of a data transfer amount or a data transfer rate associated with each thread of the plurality of threads may be tracked to identify a first thread and a second thread. The data transfer amount or the data transfer rate may be tracked in real-time or near real-time, based on the assignment of the plurality of threads to the plurality of processing clusters. The control circuit 106 may track, in real-time or near real-time, via a monitoring service, at least one of the data transfer amount or the data transfer rate associated with each thread based on the assignment of the plurality of threads to the plurality of processing clusters 108 to identify the first thread 116 and the second thread 118.

At 406, it may be determined, upon the identification of the first thread and the second thread, that the first thread and the second thread are assigned to different processing clusters of the plurality of processing clusters 108. Upon the identification of the first thread 116 and the second thread 118, the control circuit 106 may determine that the first thread 116 and the second thread 118 are assigned to different processing clusters of the plurality of processing clusters 108. In an example, the first thread 116 may be assigned to the first processing cluster 130 and the second thread 118 may be assigned to the second processing cluster 132.

At 408, based on the determination that the first thread and the second thread are assigned to the different processing clusters, an interrupt to halt the execution of at least one of the first thread and the second thread may be triggered. The control circuit 106 may trigger the interrupt to halt the current execution of any of the first thread 116 or the second thread 118 based on the determination that first thread 116 and the second thread 118 may be assigned to different processing clusters. In an example, the control circuit 106 may trigger the interrupt to halt the execution of at least one of the execution of the first thread 116 on the first processing cluster 130 or the second thread 118 on the second processing cluster 132.

At 410, migration of the at least one of the first thread and the second thread upon the triggering of the interrupt to a single processing cluster of the plurality of processing clusters 108 may be managed. Upon halting the execution of at least one of the first thread 116 or the second thread 118, the control circuit 106 may reassign or migrate (e.g., switch the context of the current execution) of at least one of the first thread 116 and the second thread 118 from the current processing cluster to a single processing cluster. Thus, the first thread 116 may be reassigned (e.g., migrated) to the second processing cluster 132, the second thread 118 may be reassigned to the first processing cluster 130, or both the first thread 116 and the second thread 118 may be reassigned to a new processing cluster based on the one or more cluster assignment parameters. Thus, a current state of execution of the thread may be loaded on the assigned processing cluster to coordinate the execution of the at least one of the first thread 116 and the second thread 118 on the single processing cluster.

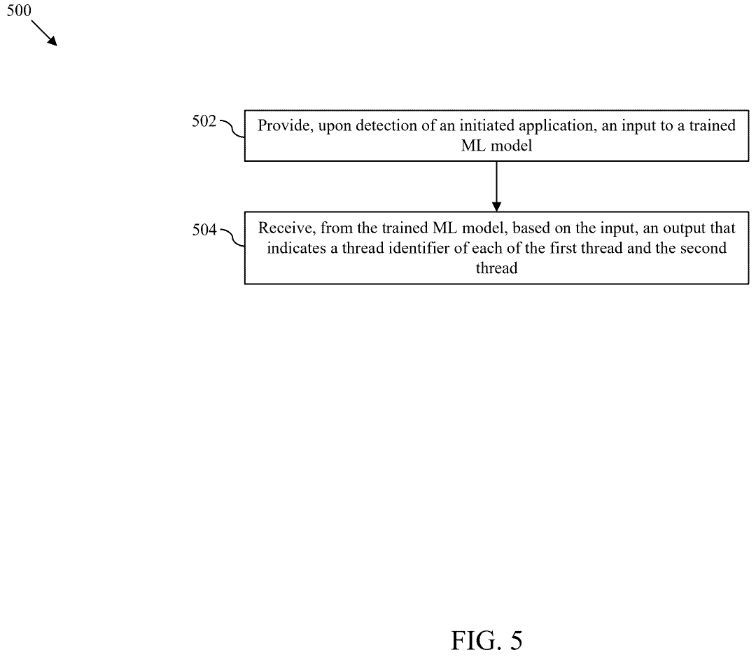

FIG. 5 is a diagram that illustrates flowchart 500 of a method (e.g., a process) executed by the control circuit 106 of the system 102 to identify threads based on a trained machine learning model, for assignment on the single processing cluster in accordance with various aspects of the present disclosure. FIG. 5 is described in conjunction with FIG. 1.

At 502, an input to a trained ML model may be provided upon the detection of the initiated application. The control circuit 106 may provide an input to a trained ML model. For explaining FIG. 5, it is assumed that the trained ML model may be the local ML model 128. In one aspect, the control circuit 106 may provide the input to the local ML model 128 based on at least one of the absence of the first telemetry logs 126 associated with the application 112 in the memory 104 or the performance profile of the system 102. Further, the input may be at least one of an identifier of the application 112, details of the workload 114, real-time data transferred between the threads of the application 112, or the like.

At 504, an output indicating a thread identifier of each of the first thread and the second thread, may be received from the trained ML model, based on the input. The control circuit 106 may receive the output from the trained ML model (e.g., the local ML model 128) based on the input. Further, the received output may indicate a thread identifier of each of the first thread 116 and the second thread 118. The control circuit 106 may thus identify the workload 114 and the first thread 116 and the second thread 118 based on the received output.

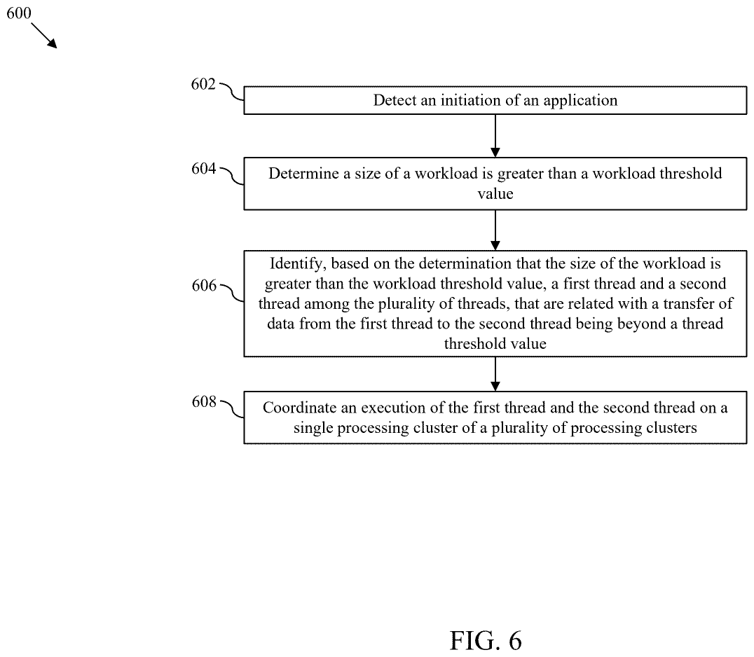

FIG. 6 is a diagram that illustrates a high-level flowchart 600 of a method (e.g., a process) executed by the control circuit 106 of the system 102 in accordance with certain aspects of the present disclosure. FIG. 6 is described in conjunction with FIG. 1.

At 602, an initiation of an application may be detected. The control circuit 106 may detect the initiation of the application 112 upon a launch of the application 112.

At 604, a size of the workload of the application may be determined to be greater than a workload threshold value. The control circuit 106 may determine a size of the workload 114. The determined size of the workload 114 may be greater than the workload threshold value. The size of the workload 114 may be determined based on at least one of the first telemetry logs 126, the second telemetry logs 158, the local ML model 128, or the tracked amount of the data transfer in real-time or near real-time associated with the application 112.

At 606, based on the determination that the size of the workload may be greater than the workload threshold value, a first thread and a second thread among the plurality of threads may be identified. The first thread and the second thread may be related with a transfer of data from the first thread to the second thread being beyond a thread threshold value. The control circuit 106 may identify the first thread 116 and the second thread 118 among the plurality of threads, based on the determination that the size of the workload 114 may be greater than the workload threshold value. Further, the first thread 116 and the second thread 118 may be related with a transfer of data from the first thread 116 to the second thread 118, being beyond the thread threshold value. The first thread 116 and the second thread 118 may be identified based on at least one of first telemetry logs 126, the second telemetry logs 158, the local ML model 128, or the tracked amount of the data transfer or the tracked rate of the data transfer in real-time or near real-time associated with the application 112.

At 608, an execution of the first thread and the second thread on a single processing cluster of a plurality of processing clusters may be coordinated. The control circuit 106 may coordinate the execution of the first thread 116 and the second thread 118 on a single processing cluster such as the first processing cluster 130 based on one or more cluster assignment parameters such as the affinity parameter, the availability parameter, the performance parameter, the operational parameter, or the like.

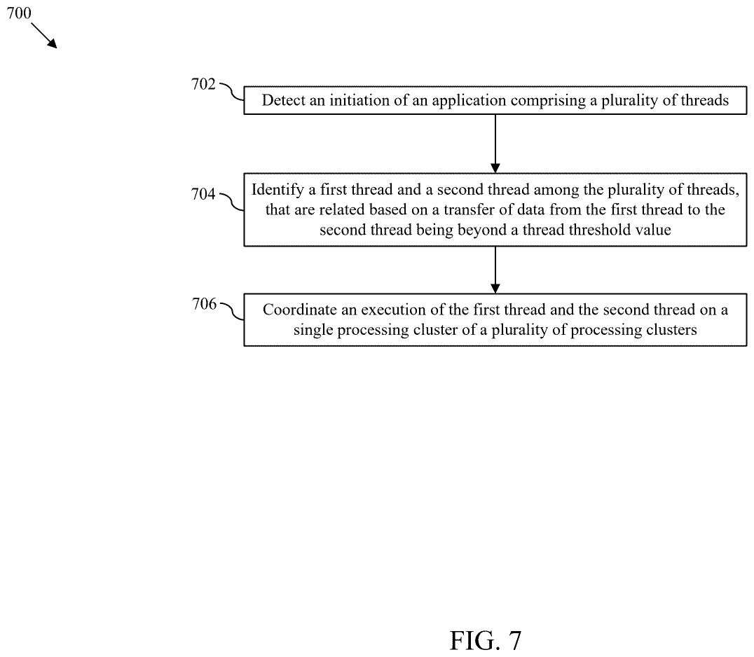

FIG. 7 is a diagram that illustrates a high-level flowchart 700 of a method (e.g., a process) executed by the control circuit 106 of the system 102 in accordance with further aspects of the present disclosure. FIG. 7 is described in conjunction with FIG. 1.

At 702, an initiation of an application comprising a plurality of threads may be detected. The control circuit 106 may detect the initiation of the application 112 and determine a size of the workload 114 being greater than the workload threshold value. Further, the application 112 may comprise a plurality of threads.

At 704, a first thread and a second thread among the plurality of threads, that are related based on a transfer of data from the first thread to the second thread being beyond a thread threshold value may be identified. The control circuit 106 may further identify the first thread 116 and the second thread 118 among the plurality of threads that are related with each other based on the transfer of data from the first thread 116 to the second thread 118 being beyond the thread threshold value. Further, the identification of the first thread 116 and the second thread 118 may be based on at least one of the first telemetry logs 126, the second telemetry logs 158, the local ML model 128, the tracked transfer of data (e.g., the amount and/or the rate) in real-time or near real-time associated with the application 112, or the like.

At 706, an execution of the first thread and the second thread on a single processing cluster of a plurality of processing clusters may be coordinated. The control circuit 106 may coordinate the execution of the first thread 116 and the second thread 118 on a single processing cluster of the plurality of processing clusters 108. The control circuit 106 may assign the first thread 116 and the second thread 118 to the first processing cluster 130 based on the one or more cluster assignment parameters.

The system 102 may provide a solution to assign threads that are related based on a transfer of data between the threads (e.g., from the first thread 116 to the second thread 118) being beyond the thread threshold value, to the same processing cluster. The first thread 116 and the second thread 118 may be identified by way of any of telemetry logs (such as the first telemetry logs 126 or the second telemetry logs 158), tracked real-time transfer of data between the first thread 116 and the second thread 118, and prediction by the local ML model 128. The assignment of the execution of the first thread 116 and the second thread 118 to the same processing cluster ensures a reduced data transfer latency and access latency as compared to assigning the first thread 116 and the second thread 118 to different processing clusters.

The present disclosure may further offer a solution to identify the first thread 116 and the second thread 118 by tracking the real-time transfer of data between the threads. Thus, for new applications which may not have been executed previously on the system 102, the first thread 116 and the second thread 118 may be identified based on the tracked real-time transfer of data being beyond the thread threshold value. Further, such tracked transfer of data and the user feedback may be provided to further train the local ML model 128 to fine-tune and personalize the local ML model 128 on the system 102. Thus, an experience of the user may be improved over conventional solutions that do not provide such personalized user experiences. Further, the assignment of the first thread 116 and the second thread 118 to a single processing cluster may enable low consumption of power by the system 102 as compared to conventional solutions.

In addition, the present disclosure may further provide an option to a user to enable the control circuit 106 to opt for the service to coordinate the scheduling of threads to a single processing cluster. In an example, the control circuit 106 may enable the coordination of the threads to the single processing cluster by default for a selected set of applications or by detecting a trigger based on a selection to opt for the service, or the like.

Techniques consistent with the present disclosure provide, among other features, systems, and methods for coordinating execution of threads on a single processing cluster.

Some implementation examples are described in the following numbered aspects:

Aspect 1: A method for coordinating execution of threads at a control circuit, comprising: detecting initiation of an application comprising a workload; determining a size of the workload is greater than a workload threshold value; identifying, based on the size of the workload being greater than the workload threshold value, at least a first thread and a second thread, among a plurality of threads of the workload, that are related with a transfer of data from the first thread to the second thread being beyond a thread threshold value; and coordinating an execution of the first thread and the second thread on a single processing cluster of a plurality of processing clusters.

Aspect 2: The method of aspect 1, wherein the first thread is a sender thread and the second thread is a receiver thread.

Aspect 3: The method of aspect 2, wherein the coordination of the execution of the first thread and the second thread on the single processing cluster is based on one or more cluster assignment parameters.

Aspect 4: The method of any of aspects 1 through 3, wherein identifying the first thread and the second thread comprises determining an amount of data transfer from the first thread to the second thread based on telemetry logs associated with the application.

Aspect 5: The method of aspect 4, further comprising generating the telemetry logs associated with historical execution of a plurality of applications, wherein at least one application of the plurality of applications is similar to the initiated application.

Aspect 6: The method of aspect 5, further comprising storing the generated telemetry logs in a memory of a system that may include the control circuit.

Aspect 7: The method of aspect 6, further comprising accessing the stored telemetry logs from the memory for the determination of the amount of the data transfer between the first thread and the second thread.

Aspect 8: The method of aspect 5, wherein the telemetry logs are stored in a cloud database.

Aspect 9: The method of aspect 8, further comprising accessing the stored telemetry logs in the cloud database for the determination of the amount of the data transfer between the first thread and the second thread.

Aspect 10: The method of any of aspects 4 through 9, wherein the telemetry logs comprise at least identifiers of a plurality of workloads associated with each historical execution of the plurality of applications, a size of each of the plurality of workloads, and thread identifiers associated with historical first and second threads of the plurality of workloads.

Aspect 11: The method of any of aspects 1 through 3, further comprising providing, upon the detection of the initiated application, an input to a trained machine learning model, wherein the input comprises one or more parameters associated with the application.

Aspect 12: The method of aspect 11, further comprising receiving, from the trained machine learning model, based on the input, an output that indicates a thread identifier of each of the first thread and the second thread, wherein the identification of the first thread and the second thread is further based on the output.

Aspect 13: The method of any of aspects 11 and 12, wherein one of a memory of a system that may include the control circuit, may store the trained machine learning model, or the trained machine learning model may be stored on a cloud database.

Aspect 14: The method of any of aspects 1 through 3, further comprising assigning the plurality of threads to the plurality of processing clusters prior to determining the size of the workload.

Aspect 15: The method of aspect 14, further comprising tracking, in real-time or near real-time, at least one of a data transfer amount or a data transfer rate associated with each thread of the plurality of threads based on the assignment of the plurality of threads to the plurality of processing clusters, wherein the identification of the first thread and the second thread is further based on the tracked at least one of the data transfer amount or the data transfer rate associated with each thread of the plurality of threads.

Aspect 16: The method of aspect 15, further comprising: determining, upon the identification of the first thread and the second thread based on the tracked at least one of the data transfer amount or the data transfer rate associated with each thread of the plurality of threads, whether the first thread and the second thread are assigned to different processing clusters of the plurality of processing clusters; and triggering, based on the determination that the first thread and the second thread are assigned to the different processing clusters, an interrupt to halt the execution of at least one of the first thread and the second thread.

Aspect 17: The method of aspect 16, further comprising managing migration of at least one of the first thread and the second thread upon the triggering of the interrupt, to the single processing cluster, wherein the coordination of the execution of the at least one of the first thread and the second thread on the single processing cluster is further based on the migration of the at least one of the first thread and the second thread.

Aspect 18: The method of any of aspects 1 through 17, wherein the execution of the first thread and the second thread on the single processing cluster is coordinated based on a number of the first thread and the second thread being less than or equal to a number of cores in the single processing cluster.

Aspect 19: The method of any of aspects 1 through 18, wherein the execution of the first thread and the second thread on the single processing cluster is coordinated based on a priority level associated with each of the first thread and the second thread.

Aspect 20: The method of any of aspects 1 through 19, wherein the first thread and the second thread are identified based on a set of power-related parameters associated with the system.

Aspect 21: A method for coordinating execution of threads by a control circuit, comprising: detecting initiation of an application comprising a plurality of threads; identifying at least a first thread and a second thread among the plurality of threads, that are related with a transfer of data from the first thread to the second thread being beyond a thread threshold value; and coordinating an execution of the first thread and the second thread on a single processing cluster of the plurality of processing clusters.

Aspect 22: The method of aspect 21, wherein the execution of the first thread and the second thread on the single processing cluster is coordinated based on a priority level associated with each of the first thread and the second thread.

Aspect 23: The method of any of aspects 21 and 22, further comprising determining a size of a workload of the application, is greater than a workload threshold value, wherein the workload may comprise the first thread and the second thread.

Aspect 24: The method of aspect 23, further comprising selecting a mode of identification to determine the size of the workload via at least one of telemetry logs, a monitoring service, or a trained machine learning (ML) model.

Aspect 25: The method of aspect 24, further comprising determining an amount of data transfer from the first thread to the second thread based on the telemetry logs associated with the application, wherein the mode of identification is via the telemetry logs.

Aspect 26: The method of aspect 25, further comprising: generating the telemetry logs associated with historical execution of a plurality of applications, wherein at least one application of the plurality of applications is similar to the initiated application; storing the telemetry logs in a memory associated with the control circuit; and accessing the stored telemetry logs for the determination of the amount of the data transfer between the first thread and the second thread.

Aspect 27: The method of aspect 26, further comprising periodically updating the stored telemetry logs.

Aspect 28: The method of aspect 24, further comprising executing the trained ML model to determine the size of the workload based on the mode of identification being via the trained ML model.

Aspect 29: The method of aspect 28, further comprising: providing, upon the detection of the initiated application, an input to the trained ML model, wherein the input comprises one or more parameters associated with the application; and receiving, from the trained ML model, based on the input, an output that indicates a thread identifier of each of the first thread and the second thread, wherein the identification of the first thread and the second thread is further based on the output.

Aspect 30: The method of aspect 29, further comprising preprocessing the input prior to providing the input to the trained ML model.

Aspect 31: The method of aspect 24, further comprising executing the monitoring service based on the mode of identification being via the monitoring service.

Aspect 32: The method of aspect 31, further comprising: assigning the plurality of threads to the plurality of processing clusters prior to the determination of the size of the workload; and tracking, in real-time or near real-time, at least one of a data transfer amount or a data transfer rate associated with each thread of the plurality of threads based on the assignment of the plurality of threads to the plurality of processing clusters, wherein the identification of the first thread and the second thread is further based on the tracked at least one of the data transfer amount or the data transfer rate associated with each thread of the plurality of threads.

Aspect 33: The method of aspect 32, further comprising: determining, upon the identification of the first thread and the second thread based on the tracked at least one of the data transfer amount or the data transfer rate associated with each thread of the plurality of threads, whether the first thread and the second thread are assigned to different processing clusters of the plurality of processing clusters; triggering, based on the determination that the first thread and the second thread are assigned to the different processing clusters, an interrupt to halt the execution of at least one of the first thread and the second thread; and managing migration of the at least one of the first thread and the second thread upon the triggering of the interrupt, to the single processing cluster, wherein the coordination of the execution of the at least one of the first thread and the second thread on the single processing cluster is further based on the migration of the at least one of the first thread and the second thread.

Aspect 34: The method of any of aspects 21 through 33, further comprising assigning the first thread and the second thread for execution to a corresponding core of the single processing cluster.

Aspect 35: The method of any of aspects 21 through 34, wherein the coordination of the execution of the first thread and the second thread on the single processing cluster is based on one or more cluster assignment parameters.

Aspect 36: The method of aspect 35, wherein the one or more cluster assignment parameters may include an affinity parameter, an availability parameter, a performance parameter, or an operational parameter.

Aspect 37: The method of any of aspects 21 through 36, further comprising assessing a set of power-related parameters that may be indicative of a performance profile of a system comprising the control circuit, to identify the first thread and the second thread.

Aspect 38: The method of any of aspects 21 through 37, wherein the first thread is a sender thread and the second thread is a receiver thread.

Aspect 39: An apparatus for coordinating execution of threads, comprising: a processor; a memory coupled with the processor; and instructions stored in the memory and executable by the processor to cause the apparatus to perform a method of any of aspects 1 through 20.

Aspect 40: An apparatus for coordinating execution of threads at a control circuit, comprising at least one means for performing a method of any of aspects 1 through 20.

Aspect 41: A non-transitory computer-readable medium storing code for coordinating execution of threads, at a control circuit, the code comprising instructions executable by a processor to perform a method of any of aspects 1 through 20.

Aspect 42: An apparatus for coordinating execution of threads at a control circuit, comprising: a processor; a memory coupled with the processor; and instructions stored in the memory and executable by the processor to cause the apparatus to perform a method of any of aspects 21 through 38.

Aspect 43: An apparatus for coordinating execution of threads at a control circuit, comprising at least one means for performing a method of any of aspects 21 through 38.

Aspect 44: A non-transitory computer-readable medium storing code for coordinating execution of threads at a control circuit, the code comprising instructions executable by a processor to perform a method of any of aspects 21 through 38.

It should be noted that the methods described herein describe possible implementations, and that the operations and the steps may be rearranged or otherwise modified and that other implementations are possible. Further, aspects from two or more of the methods may be combined.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A system, comprising:
a memory; and
a control circuit coupled to the memory, wherein the control circuit is configured to:
detect initiation of an application comprising a workload;
determine a size of the workload is greater than a workload threshold value, wherein the workload comprises a plurality of threads;
identify, based on the size of the workload being greater than the workload threshold value, at least a first thread and a second thread, among the plurality of threads, that are related with a transfer of data from the first thread to the second thread being beyond a thread threshold value; and
coordinate an execution of the first thread and the second thread on a single processing cluster of a plurality of processing clusters.

2. The system of claim 1, wherein the first thread is a sender thread and the second thread is a receiver thread.

3. The system of claim 1, wherein the coordination of the execution of the first thread and the second thread on the single processing cluster is based on one or more cluster assignment parameters.

4. The system of claim 1, wherein to identify the first thread and the second thread, the control circuit is further configured to determine an amount of data transfer from the first thread to the second thread based on telemetry logs associated with the application.

5. The system of claim 4, wherein the control circuit is further configured to generate the telemetry logs associated with historical execution of a plurality of applications, and wherein at least one application of the plurality of applications is similar to the initiated application.

6. The system of claim 5, wherein the control circuit is further configured to store the generated telemetry logs in the memory, and wherein the control circuit is further configured to access the stored telemetry logs for the determination of the amount of the data transfer between the first thread and the second thread.

7. The system of claim 5, wherein
the telemetry logs are stored in a cloud database, and wherein
the control circuit is further configured to access the stored telemetry logs in the cloud database for the determination of the amount of the data transfer between the first thread and the second thread.

8. The system of claim 5, wherein the telemetry logs comprise at least identifiers of a plurality of workloads associated with each historical execution of the plurality of applications, a size of each of the plurality of workloads, and thread identifiers associated with historical first and second threads of the plurality of workloads.

9. The system of claim 1, wherein the control circuit is further configured to:
provide, upon the detection of the initiated application, an input to a trained machine learning model, wherein the input comprises one or more parameters associated with the application; and
receive, from the trained machine learning model, based on the input, an output that indicates a thread identifier of each of the first thread and the second thread, wherein the identification of the first thread and the second thread is further based on the output.

10. The system of claim 9, wherein one of the memory is configured to store the trained machine learning model, or the trained machine learning model is stored on a cloud database.

11. The system of claim 1, wherein prior to the determination of the size of the workload, the control circuit is further configured to assign the plurality of threads to the plurality of processing clusters.

12. The system of claim 11, wherein the control circuit is further configured to track, in real-time or near real-time, at least one of a data transfer amount or a data transfer rate associated with each thread of the plurality of threads based on the assignment of the plurality of threads to the plurality of processing clusters, wherein the identification of the first thread and the second thread is further based on the tracked at least one of the data transfer amount or the data transfer rate associated with each thread of the plurality of threads.

13. The system of claim 12, wherein the control circuit is further configured to:
determine, upon the identification of the first thread and the second thread based on the tracked at least one of the data transfer amount or the data transfer rate associated with each thread of the plurality of threads, whether the first thread and the second thread are assigned to different processing clusters of the plurality of processing clusters; and
trigger, based on the determination that the first thread and the second thread are assigned to the different processing clusters, an interrupt to halt the execution of at least one of the first thread and the second thread.

14. The system of claim 13, wherein the control circuit is further configured to manage migration of the at least one of the first thread and the second thread upon the triggering of the interrupt, to the single processing cluster, wherein the coordination of the execution of the at least one of the first thread and the second thread on the single processing cluster is further based on the migration of the at least one of the first thread and the second thread.

15. The system of claim 1, wherein the control circuit is further configured to coordinate the execution of the first thread and the second thread on the single processing cluster based on a number of the first thread and the second thread being less than or equal to a number of cores in the single processing cluster.

16. The system of claim 15, wherein the control circuit is further configured to coordinate the execution of the first thread and the second thread on the single processing cluster based on a priority level associated with each of the first thread and the second thread.

17. The system of claim 1, wherein the control circuit is further configured to identify the first thread and the second thread based on a set of power-related parameters associated with the system.

18. A method executed by a control circuit, the method comprising:
detecting initiation of an application comprising a workload;
determining a size of the workload is greater than a workload threshold value, wherein the workload comprises a plurality of threads;
identifying, based on the size of the workload being greater than the workload threshold value, at least a first thread and a second thread, among the plurality of threads, that are related with a transfer of data from the first thread to the second thread being beyond a thread threshold value; and
coordinating an execution of the first thread and the second thread on a single processing cluster of a plurality of processing clusters.

19. A system, comprising:
a plurality of processing clusters; and
a control circuit coupled to the plurality of processing clusters, wherein the control circuit is configured to:
detect initiation of an application comprising a plurality of threads;
identify at least a first thread and a second thread among the plurality of threads, that are related based on a transfer of data from the first thread to the second thread being beyond a thread threshold value; and
coordinate an execution of the first thread and the second thread on a single processing cluster of the plurality of processing clusters.

20. The system of claim 19, wherein the control circuit is further configured to coordinate the execution of the first thread and the second thread on the single processing cluster based on a priority level associated with each of the first thread and the second thread.
